(19) United States
(12) Patent Application Publication
(10) Pub. No.: US 2023/0282205 A1
(43) Pub. Date: Sep. 7, 2023

(54) CONVERSATION DIARIZATION BASED ON AGGREGATE DISSIMILARITY

(71) Applicant: Raytheon Applied Signal Technology, Inc., Sunnyvale, CA (US)

(72) Inventor: Jonathan C. Wintrode, Annapolis, MD (US)

(21) Appl. No.: 17/653,106

(22) Filed: Mar. 1, 2022

(51) Int. Cl. G10L 15/08; G10L 15/04; G10L 15/02; H04S 3/00; G10L 15/22

(52) U.S. Cl. CPC G10L 15/08; G10L 15/04; G10L 15/02; H04S 3/008; G10L 15/22

(57) ABSTRACT

A method includes obtaining input audio data that captures multiple conversations between speakers and extracting features of segments of the input audio data. The method also includes generating at least a portion of a similarity matrix based on the extracted features, where the similarity matrix identifies similarities of the segments of the input audio data to one another. The method further includes identifying dissimilarity values associated with different corresponding regions of the similarity matrix that are associated with different possible conversation changes. In addition, the method includes identifying one or more locations of conversation changes within the input audio data based on the dissimilarity values.

### TECHNICAL FIELD

This disclosure is generally directed to audio processing systems. More specifically, this disclosure is directed to conversation diarization based on aggregate dissimilarity.

### BACKGROUND

Speaker diarization generally refers to the process of analyzing audio data in order to identify different speakers. Speaker diarization approaches often rely on a speaker identification model that processes a single-channel audio file in order to identify portions of the audio file that appear to contain audio data from a common speaker. These speaker diarization approaches typically focus on speaker-based characteristics on a global scale in order to perform the diarization.

### SUMMARY

This disclosure relates to conversation diarization based on aggregate dissimilarity.

In a first embodiment, a method includes obtaining input audio data that captures multiple conversations between speakers and extracting features of segments of the input audio data. The method also includes generating at least a portion of a similarity matrix based on the extracted features, where the similarity matrix identifies similarities of the segments of the input audio data to one another. The method further includes identifying dissimilarity values associated with different corresponding regions of the similarity matrix that are associated with different possible conversation changes. In addition, the method includes identifying one or more locations of conversation changes within the input audio data based on the dissimilarity values.

In a second embodiment, an apparatus includes at least one processing device configured to obtain input audio data that captures multiple conversations between speakers and extract features of segments of the input audio data. The at least one processing device is also configured to generate at least a portion of a similarity matrix based on the extracted features, where the similarity matrix identifies similarities of the segments of the input audio data to one another. The at least one processing device is further configured to identify dissimilarity values associated with different corresponding regions of the similarity matrix that are associated with different possible conversation changes and identify one or more locations of conversation changes within the input audio data based on the dissimilarity values.

In a third embodiment, a non-transitory computer readable medium contains instructions that when executed cause at least one processor to obtain input audio data that captures multiple conversations between speakers and extract features of segments of the input audio data. The medium also contains instructions that when executed cause the at least one processor to generate at least a portion of a similarity matrix based on the extracted features, where the similarity matrix identifies similarities of the segments of the input audio data to one another. The medium further contains instructions that when executed cause the at least one processor to identify dissimilarity values associated with different corresponding regions of the similarity matrix that are associated with different possible conversation changes and identify one or more locations of conversation changes within the input audio data based on the dissimilarity values.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting conversation diarization based on aggregate dissimilarity according to this disclosure;

FIG. 2 illustrates an example device supporting conversation diarization based on aggregate dissimilarity according to this disclosure;

FIG. 3 illustrates an example process for conversation diarization based on aggregate dissimilarity according to this disclosure;

FIG. 4 illustrates an example similarity matrix that may be used during conversation diarization according to this disclosure;

FIG. 5 illustrates an example multi-channel audio input that may be processed during conversation diarization based on aggregate dissimilarity according to this disclosure;

FIG. 6 illustrates example results associated with conversation diarization based on aggregate dissimilarity according to this disclosure; and

FIG. 7 illustrates an example method for conversation diarization based on aggregate dissimilarity according to this disclosure.

### DETAILED DESCRIPTION

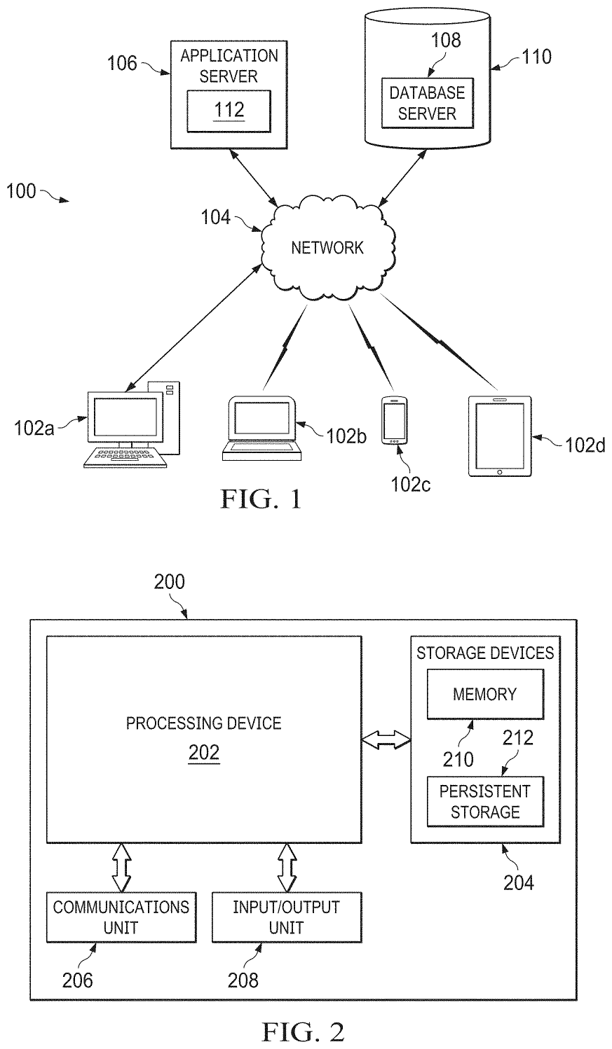

FIGS. 1 through 7, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, speaker diarization generally refers to the process of analyzing audio data in order to identify different speakers. Speaker diarization approaches often rely on a speaker identification model that processes a single-channel audio file in order to identify portions of the audio file that appear to contain audio data from a common speaker. These speaker diarization approaches typically focus on speaker-based characteristics on a global scale in order to perform the diarization.

Unfortunately, while these types of approaches are useful for speaker diarization, they are generally much less useful for conversation diarization. Conversation diarization generally refers to the process of analyzing audio data in order to identify different conversations taking place between speakers. One example goal of conversation diarization may be to identify where one conversation ends and another conversation begins within single-channel or multi-channel audio data. Speaker diarization approaches typically assume that speakers take relatively-short turns engaging in conversion. However, overall conversations themselves are typically much longer in duration. As a result, speaker diarization approaches tend to vastly over-generate the number of conversation breakpoints between incorrectly-identified conversations within audio data.

This disclosure provides various techniques for conversation diarization based on aggregate dissimilarity. As described in more detail below, single-channel or multi-channel audio data (such as audio content containing audio information or audio-video content containing audio and video information) may be obtained and analyzed in order to identify multiple conversations captured within the audio data. The analysis performed here to identify conversations may generally involve extracting feature vectors from segments of the obtained audio data, determining a similarity matrix based on the extracted feature vectors, and identifying regions of high aggregate dissimilarity in the similarity matrix. The regions of high aggregate dissimilarity may be located in off-diagonal positions within the similarity matrix and can be indicative of conversation changes, and these regions can therefore be used to calculate dissimilarity values associated with the segments of audio data. The dissimilarity values can be generated over time and processed (such as by performing smoothing and peak detection), and the processed results can be used to identify the multiple conversations in the audio data and any related characteristics (such as start and stop times of the conversations).

In this way, these techniques for conversation diarization allow audio data to be processed and different conversations within the audio data to be identified more effectively. Among other reasons, this is because the use of dissimilarity enables more effective identification of different conversations, since similarity is generally used for identifying similar regions associated with the same speaker during a single conversation (which is generally not suitable for conversation diarization). Moreover, the described techniques for conversation diarization are effective even when the same speaker is participating in multiple conversations over time. In addition, by focusing on identifying regions of high aggregate dissimilarity located in off-diagonal positions, this becomes a local analysis problem (rather than a global analysis problem), which can speed up the processing of the audio data and reduce the overall number of computations needed to identify the different conversations in the audio data.

Note that the conversation diarization techniques described here may be used in any number of applications and for any suitable purposes. For example, in some applications, the conversation diarization techniques may be used to analyze different source streams of audio data for information and intelligence value by identifying different conversations within the audio, which may allow the source data to be segmented for routing and further analysis. In other applications, the conversation diarization techniques may be used to analyze communication data captured during military operations in order to identify different conversations within the communication data, which may be useful for post-mission analysis. In still other applications, the conversation diarization techniques may be used by digital personal assistant devices (such as GOOGLE BIXBY, APPLE SIRI, or AMAZON ALEXA-based devices) to analyze incoming audio data in order to identify one or more conversations contained in the incoming audio data, which may allow for more effective actions to be performed and more effective responses to be provided. In yet other applications, the conversation diarization techniques may be used to process data associated with video or telephonic meetings, conference calls, or customer calls, which may allow for generation of transcripts of ZOOM meetings or other meetings or transcripts of calls into call centers. Of course, the conversation diarization techniques may be used in any other suitable manner. Also note that data generated by the conversation diarization techniques (such as start/stop times of conversations) may be used in any suitable manner, such as to segment audio data into different segments associated with different conversations, process different segments of audio data in different ways, and/or route different segments of audio data or processing results associated with different segments of audio data to different destinations.

FIG. 1 illustrates an example system 100 supporting conversation diarization based on aggregate dissimilarity according to this disclosure. As shown in FIG. 1, the system 100 includes multiple user devices 102a-102d, at least one network 104, at least one application server 106, and at least one database server 108 associated with at least one database 110. Note, however, that other combinations and arrangements of components may also be used here.

In this example, each user device 102a-102d is coupled to or communicates over the network 104. Communications between each user device 102a-102d and a network 104 may occur in any suitable manner, such as via a wired or wireless connection. Each user device 102a-102d represents any suitable device or system used by at least one user to provide information to the application server 106 or database server 108 or to receive information from the application server 106 or database server 108. Any suitable number(s) and type(s) of user devices 102a-102d may be used in the system 100. In this particular example, the user device 102a represents a desktop computer, the user device 102b represents a laptop computer, the user device 102c represents a smartphone, and the user device 102d represents a tablet computer. However, any other or additional types of user devices may be used in the system 100. Each user device 102a-102d includes any suitable structure configured to transmit and/or receive information.

The network 104 facilitates communication between various components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate communication protocol or protocols.

The application server 106 is coupled to the network 104 and is coupled to or otherwise communicates with the database server 108. The application server 106 supports the execution of one or more applications 112, at least one of which is designed to perform conversation diarization based on aggregate dissimilarity. For example, an application 112 may be configured to obtain audio data (such as single-channel or multi-channel audio data associated with audio or audio-video content) and analyze the audio data to identify multiple conversations contained in the audio data. The application 112 may also identify one or more characteristics of each identified conversation, such as its start and stop times. The same application 112 or a different application 112 may use the identified conversations and their characteristics in any suitable manner, such as to segment the audio data and process different segments of audio data and/or route the different segments of audio data or their associated processing results to one or more suitable destinations.

The database server 108 operates to store and facilitate retrieval of various information used, generated, or collected by the application server 106 and the user devices 102a-102d in the database 110. For example, the database server 108 may store various information in database tables or other data structures in the database 110. In some embodiments, the database 110 can store the audio data being processed by the application server 106 and/or results of the audio data processing. The audio data processed here may be obtained from any suitable source(s), such as from one or more user devices 102a-102d or one or more external sources. Note that the database server 108 may also be used within the application server 106 to store information, in which case the application server 106 may store the information itself.

Although FIG. 1 illustrates one example of a system 100 supporting conversation diarization based on aggregate dissimilarity, various changes may be made to FIG. 1. For example, the system 100 may include any number of user devices 102a-102d, networks 104, application servers 106, database servers 108, and databases 110. Also, these components may be located in any suitable locations and might be distributed over a large area. Further, certain components here may be replaced by other components that can perform suitable functions, such as when a different computing device is used in place of the application server 106 or a different storage is used in place of the database server 108/database 110. In addition, while FIG. 1 illustrates one example operational environment in which conversation diarization based on aggregate dissimilarity may be used, this functionality may be used in any other suitable device or system.

FIG. 2 illustrates an example device 200 supporting conversation diarization based on aggregate dissimilarity according to this disclosure. One or more instances of the device 200 may, for example, be used to at least partially implement the functionality of the application server 106 of FIG. 1. However, the functionality of the application server 106 may be implemented in any other suitable manner. In some embodiments, the device 200 shown in FIG. 2 may form at least part of a user device 102a-102d, application server 106, or database server 108 in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network. The communications unit 206 may support communications through any suitable physical or wireless communication link(s). As a particular example, the communications unit 206 may support communication over the network(s) 104 of FIG. 1.

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

In some embodiments, the instructions executed by the processing device 202 include instructions that implement the functionality of the application server 106. Thus, for example, the instructions executed by the processing device 202 may obtain audio data from one or more sources and process the audio data to perform conversation diarization based on aggregate dissimilarity. The instructions executed by the processing device 202 may also use the results of the conversation diarization to segment the audio data, process the audio data, route the audio data or the processing results, and/or perform any other desired function(s) based on identified conversations in the audio data.

Although FIG. 2 illustrates one example of a device 200 supporting conversation diarization based on aggregate dissimilarity, various changes may be made to FIG. 2. For example, computing and communication devices and systems come in a wide variety of configurations, and FIG. 2 does not limit this disclosure to any particular computing or communication device or system.

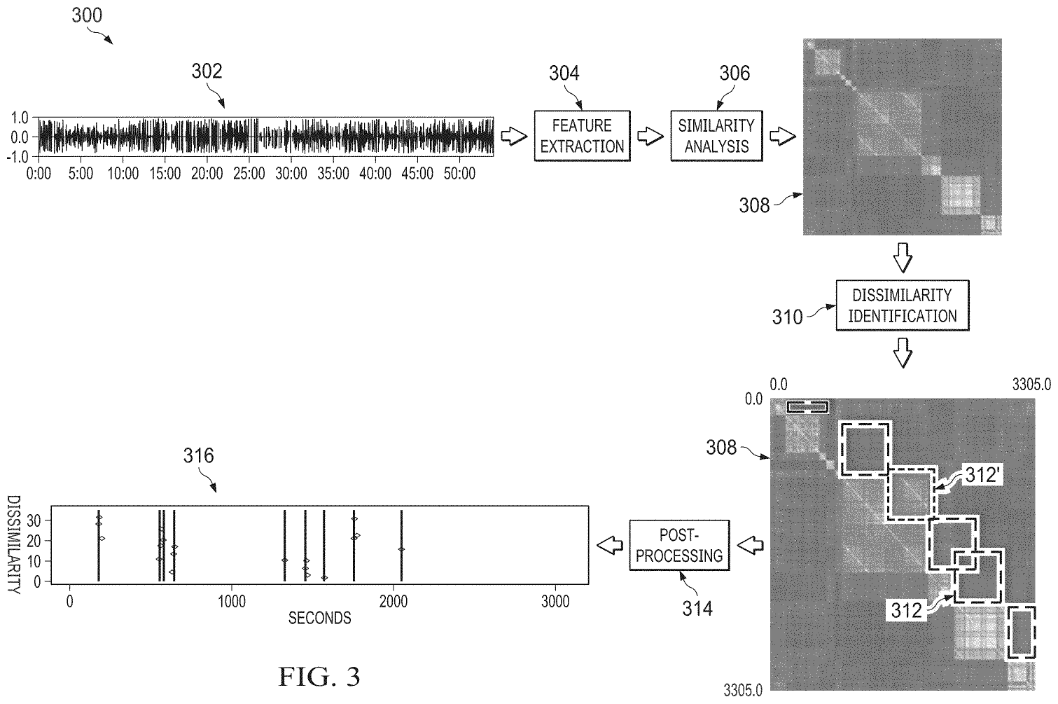

FIG. 3 illustrates an example process 300 for conversation diarization based on aggregate dissimilarity according to this disclosure. For ease of explanation, the process 300 of FIG. 3 is described as being performed by the application server 106 in the system 100 of FIG. 1, where the application server 106 is implemented using one or more instances of the device 200 of FIG. 2. However, the process 300 may be performed using any other suitable device(s) and in any other suitable system(s).

As shown in FIG. 3, the process 300 generally involves receiving and processing input audio data 302. The audio data 302 can be obtained from any suitable source(s) and may have any suitable format. In some cases, the audio data 302 may represent a single-channel or multi-channel audio file, and the audio file may be associated with audio-only content or audio-video content. The audio data 302 may also be obtained in any suitable manner, such as from a database 110, from a user device 102a-102d, or from another source in a real-time or non-real-time manner.

The audio data 302 here is provided to a feature extraction function 304, which generally operates to extract audio features of the audio data 302 and form feature vectors. The feature extraction function 304 may use any suitable technique to identify audio features of the audio data 302. For example, the feature extraction function 304 may represent a trained machine learning model, such as a convolution neural network (CNN) or other type of machine learning model, that is trained to process audio data 302 using various convolution, pooling, or other layers in order to extract the feature vectors from the audio data 302. In some embodiments, the feature extraction function 304 processes segments of the audio data 302, such as one-second to two-second segments of the audio data 302, in order to identify feature vectors for the various segments of the audio data 302. In particular embodiments, the feature extraction function 304 may use the same type of processing that is used during speaker diarization to extract the feature vectors for the various segments of the audio data 302.

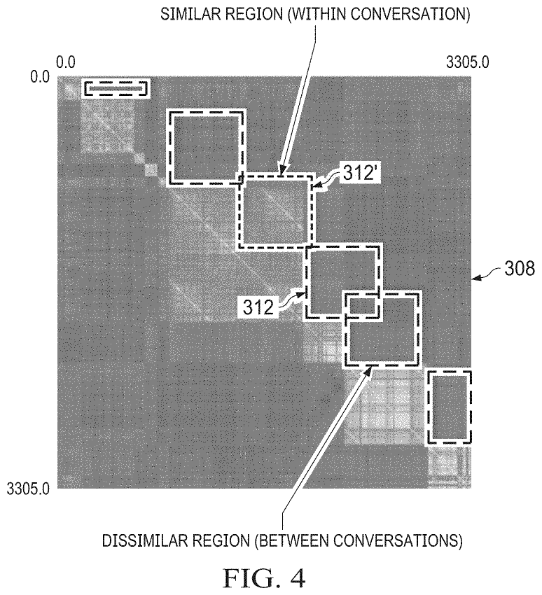

The extracted audio features are provided to a similarity analysis function 306, which generally operates to analyze the audio features in order to generate at least one similarity matrix 308 associated with the audio data 302. FIG. 4 illustrates an example similarity matrix 308 that may be used during conversation diarization according to this disclosure. The similarity matrix 308 generally identifies how the different segments of the audio data 302 are related to one another. In this example, both axes of the similarity matrix 308 represent the segments of the audio data 302. The diagonal traveling from the upper left corner to the bottom right corner of the similarity matrix 308 is defined as the main diagonal of the similarity matrix 308. That diagonal defines the closest similarities between segments since the diagonal contains the similarity of each segment of the audio data 302 to itself. As can be seen here, the similarity matrix 308 effectively functions as a heatmap, where distinct conversations appear as square “hot” regions of similar scores and where the size of a square corresponds to the length of the associated conversation.

In some embodiments, similarity between audio segments may be inversely related to values in the similarity matrix 308, meaning that higher similarities between audio segments are associated with lower values in the similarity matrix 308 and lower similarities between audio segments are associated with higher values in the similarity matrix 308. The similarity analysis function 306 may use any suitable technique to identify the similarities of the segments of the audio data 302 to one another. For instance, in some embodiments, the similarity analysis function 306 may use a probabilistic linear discriminant analysis (PLDA) comparison function in order to identify the similarities of the segments of the audio data 302 to one another.

The similarity matrix 308 is provided to a dissimilarity identification function 310, which generally operates to identify different regions 312 within the similarity matrix 308 and to identify dissimilarity values for the different regions 312 within the similarity matrix 308. The different regions 312 of the similarity matrix 308 are located off the main diagonal of the similarity matrix 308 and encompass different portions of the similarity matrix 308. As a result, each region 312 encompasses values within the similarity matrix 308 that are associated with different collections or subsets of the audio segments. Some or most of the regions 312 may have the same size (defined as a window size), while the regions 312 at the top left and bottom right of the similarity matrix 308 may have a smaller size since those regions 312 intersect one or more edges of the similarity matrix 308. The dissimilarity identification function 310 may identify various regions 312 along the main diagonal of the similarity matrix 308 and use values within each region 312 to calculate a dissimilarity value for that region 312. Each dissimilarity value represents a measure of how dissimilar the segments of audio data 302 associated with the values within the corresponding region 312 of the similarity matrix 308 are to one another.

The dissimilarity identification function 310 may use any suitable technique to identify the various regions 312 within the similarity matrix 308. In some embodiments, for example, the dissimilarity identification function 310 may use a sliding window to define the regions 312, where the window slides diagonally along the main diagonal of the similarity matrix 308 to define different regions 312 within the similarity matrix 308. In some cases, the window may slide one position diagonally along the main diagonal of the similarity matrix 308 in order to define regions 312 along the entire span of the main diagonal. In other cases, the dissimilarity identification function 310 may use pattern recognition or another technique to identify corners within the similarity matrix 308, where the corners are defined by collections of dissimilar values in the similarity matrix 308. The dissimilarity identification function 310 may also use any suitable technique to calculate a dissimilarity value for each region 312. In some embodiments, for instance, the dissimilarity identification function 310 calculates a dissimilarity value for each region 312 as a normalized sum of the values within that region 312 of the similarity matrix 308. In whatever manner the dissimilarity value for each region 312 is calculated, each dissimilarity value may be said to represent an “aggregate” dissimilarity since it is determined based on the similarities between multiple segments of the audio data 302.

The dissimilarity values determined by the dissimilarity identification function 310 are provided to a post-processing function 314, which generally operates to process the dissimilarity values in order to generate output characteristics 316 of detected conversations within the audio data 302. The post-processing function 314 may perform any suitable post-processing of the dissimilarity values from the dissimilarity identification function 310 in order to generate the output characteristics 316 of the detected conversations within the audio data 302. For example, the post-processing function 314 may apply filtering/smoothing and peak detection to the dissimilarity values from the dissimilarity identification function 310. The post-processing function 314 may also compare the processed versions of the dissimilarity values (such as the detected peaks of the dissimilarity values) to a threshold value in order to identify one or more regions 312 that are likely indicative of a conversation change. In some cases, each peak in the processed dissimilarity value that exceeds the threshold may be indicative of a conversation change, while each peak in the processed dissimilarity value below the threshold may not be indicative of a conversation change. This is possible since the similarity matrix 308 plots the similarities of the segments of the audio data 302, so each region 312 (which is associated with multiple segments of audio data 302) can have a dissimilarity value that indicates how closely those associated segments of audio data 302 are related to one another. Audio segments that are less related to one another would be indicative of a conversation change, and audio segments that are more related to one another would not be indicative of a conversation change.

In the particular example shown in FIGS. 3 and 4, one region 312′ is associated with a dissimilarity score that indicates the associated segments of audio data 302 in the region 312′ are more related, which can be used as an indicator that the associated segments of audio data 302 are part of the same conversation. The remaining regions 312 identified in FIGS. 3 and 4 are associated with dissimilarity scores that indicate the associated segments of audio data 302 are less related, which can be used as indicators that the associated segments of audio data 302 in those regions 312 are not part of the same conversation. Thus, the regions 312 with dissimilarity scores above the threshold may be used as identifiers of conversation changes within the audio data 302.

The output characteristics 316 generated using the process 300 may represent any suitable information regarding the detected conversations or the detected conversation changes within the audio data 302. In some embodiments, for example, the output characteristics 316 may include the start and stop times of each detected conversation within the audio data 302 or the time of each detected conversation change within the audio data 302. The output characteristics 316 may be used in any suitable, such as to segment the audio data 302 into different portions and to process or route the different portions of the audio data 302 in different ways.

Note that the window size of the regions 312 and the threshold value that is compared to the dissimilarity values can be tunable in order to adjust how the output characteristics 316 are generated. In some cases, the window size of the regions 312 and/or the threshold value may be set based on training data associated with a particular application of the process 300. For example, the training data may include training audio data having known locations of multiple conversation changes, such as known start and stop times of multiple conversations or other information that can be used to specifically identify conversations or conversation changes. The training audio data may then be used to adjust the window size of the regions 312 and the threshold value until the output characteristics 316 generated using the training audio data match the known characteristics of the conversations or conversation changes in the training audio data (at least to within a specified loss value).

Also note that the similarity analysis function 306 may determine a similarity matrix 308 for the entire span of the audio data 302, or the similarity analysis function 306 may determine similarity matrices 308 for different portions of the audio data 302. In some cases, for instance, the similarity analysis function 306 may generate a similarity matrix 308 for each sixty-second portion or other portion of the audio data 302. In situations where multiple similarity matrices 308 are generated for the audio data 302, each similarity matrix 308 may be processed as described above in order to identify conversation changes within the associated portion of the audio data 302.

Further, note that the similarity matrix 308 shown in FIGS. 3 and 4 may be represented using any suitable data structure. In some cases, the similarity matrix 308 may be represented using an n×n matrix that stores all values for all entries of a similarity matrix 308.

In other cases, the similarities of two segments of audio data may be symmetrical, meaning the similarity of segment A to segment B is the same as the similarity of segment B to segment A. Thus, the similarity matrix 308 may be symmetrical, and the data values in one of the lower portion under the main diagonal or the upper portion above the main diagonal of the similarity matrix 308 may be omitted, ignored, or set to zero or other value. In still other cases, the different regions 312 defined within the similarity matrix 308 may be said to occupy a band or range of locations within the similarity matrix 308, such as when the regions 312 are all defined within 75 pixels or other number of pixels of the main diagonal of the similarity matrix 308. In those cases, the similarity matrix 308 may be treated as a “banded” matrix in which only the values within a specified band above or below the main diagonal of the similarity matrix 308 are stored or processed (and in which the remaining values of the similarity matrix 308 may be omitted, ignored, or set to zero or other value).

In addition, note that the functions shown in or described with respect to FIG. 3 can be implemented in the application server 106 or other device in any suitable manner. For example, in some embodiments, at least some of the functions shown in or described with respect to FIG. 3 can be implemented or supported using one or more software applications or other software instructions that are executed by the processing device(s) 202 of the application server 106 or other device. In other embodiments, at least some of the functions shown in or described with respect to FIG. 3 can be implemented or supported using dedicated hardware components. In general, the functions shown in or described with respect to FIG. 3 can be performed using any suitable hardware or any suitable combination of hardware and software/firmware instructions.

Although FIG. 3 illustrates one example of a process 300 for conversation diarization based on aggregate dissimilarity, various changes may be made to FIG. 3. For example, various functions shown in FIG. 3 may be combined, further subdivided, replicated, omitted, or rearranged and additional functions may be added according to particular needs. Also, the specific contents of the audio data 302, the similarity matrix 308, and the output characteristics 316 will vary based on the audio data 302 being processed. Although FIG. 4 illustrates one example of a similarity matrix 308 that may be used during conversation diarization, various changes may be made to FIG. 4. For instance, more or fewer regions 312 may be identified within the similarity matrix 308 during processing of the similarity matrix 308.

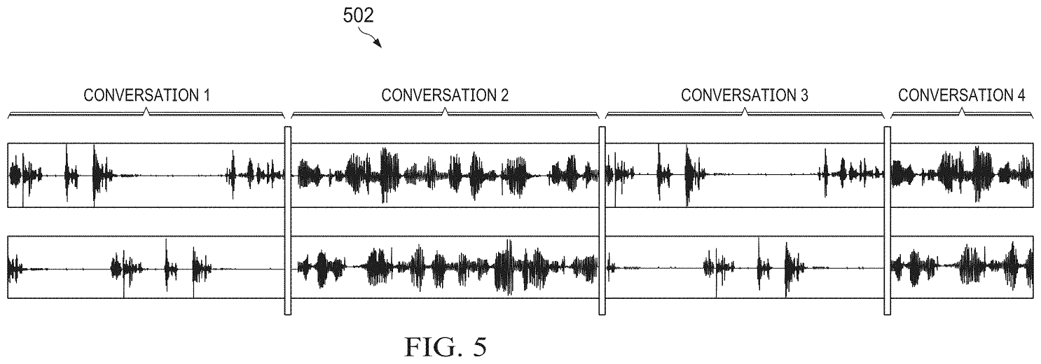

FIG. 5 illustrates an example multi-channel audio input that may be processed during conversation diarization based on aggregate dissimilarity according to this disclosure. In the discussion above with respect to FIGS. 3 and 4, the audio data 302 is assumed to be single-channel audio data. However, the process 300 may similarly be used to analyze multi-channel audio data 502 as shown in FIG. 5. The multi-channel audio data 502 may be generated and obtained in any suitable manner, such as when the multi-channel audio data 502 is collected using different microphones or other devices at different locations relative to one or more speakers.

In some embodiments, to analyze the multi-channel audio data 502, the process 300 may be used to analyze each channel of the multi-channel audio data 502 independently. For example, the process 300 may be used to analyze one channel of the audio data 502 and separately (such as sequentially or concurrently) be used to analyze another channel of the audio data 502. The results of the analyses for the different channels of the audio data 502 may then be averaged, fused, or otherwise combined to produce the output characteristics 316 for the multi-channel audio data 502 as a whole. Thus, for instance, the process 300 may compare the dissimilarity values determined for regions 312 in different similarity matrices 308 (associated with the different channels of audio data 502) to a threshold. Depending on the implementation, if one or more regions 312 at the same position in different similarity matrices 308 exceed the threshold, this may be used as an indicator of a conversation change. Note that, depending on the implementation, the same threshold value or different threshold values may be used when analyzing the different channels of the audio data 502.

Although FIG. 5 illustrates one example of a multi-channel audio input that may be processed during conversation diarization based on aggregate dissimilarity, various changes may be made to FIG. 5. For example, the specific contents of the audio data 502 will vary based on the audio data 302 being processed. Also, a multi-channel audio input may include more than two channels of audio data.

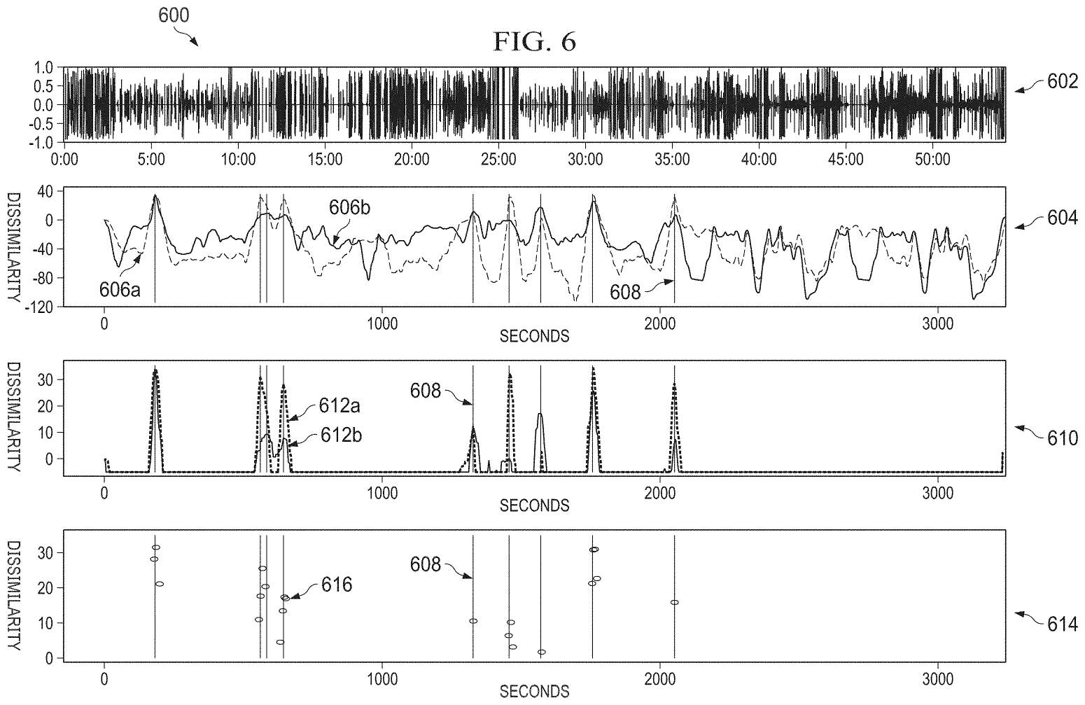

FIG. 6 illustrates example results 600 associated with conversation diarization based on aggregate dissimilarity according to this disclosure. In this example, the results 600 are associated with multi-channel audio data 602, which in this particular example includes two channels of audio data. The results 600 include a graph 604 that contains two lines 606a-606b representing the dissimilarity values determined over time for the two channels of the audio data 602. For example, the dissimilarity values represented by the lines 606a-606b may be associated with regions 312 within the similarity matrices 308 generated for the two channels of the audio data 602. Markers 608 here are used to represent the locations of known conversation changes within the audio data 602. These markers 608 are presented here to illustrate the effectiveness of the process 300 in identifying conversation changes but generally are not available during normal operation of the process 300.

The results 600 also include a graph 610 that contains two lines 612a-612b representing processed versions of the dissimilarity values determined over time for the two channels of the audio data 602. For example, the processed versions of the dissimilarity values represented by the lines 612a-612b may be generated by application of a flooring operation, a peak detection operation, and a smoothing operation performed by the post-processing function 314. As can be seen here, these operations help to enable simpler or more accurate identification of peaks in the dissimilarity values. Moreover, by identifying peaks within the dissimilarity values, the identification of conversation changes becomes a local processing problem (identifying a local maximum) rather than a global processing problem.

The post-processing function 314 can compare the processed dissimilarity values (such as the peaks of the processed dissimilarity values) to one or more thresholds, and the results of the comparisons are shown in a graph 614. The graph 614 includes various points 616 identifying where the post-processing function 314 has determined that the processed dissimilarity values exceed the associated threshold. As can be seen in the graph 614, the points 616 are located at or near the markers 608, which indicates that the process 300 can effectively identify the locations of conversation changes within the audio data 602. Note that the post-processing function 314 may apply one or more heuristics or filters to the points 616 in order to group points 616 related to the same conversation change.

Although FIG. 6 illustrates one example of results 600 associated with conversation diarization based on aggregate dissimilarity, various changes may be made to FIG. 6. For example, a wide range of audio data can be captured and processed, and the results associated with any specific collection of audio data can vary based on the contents of that specific audio data. The results shown in FIG. 6 are merely meant to illustrate example types of results that might be obtained during performance of the process 300.

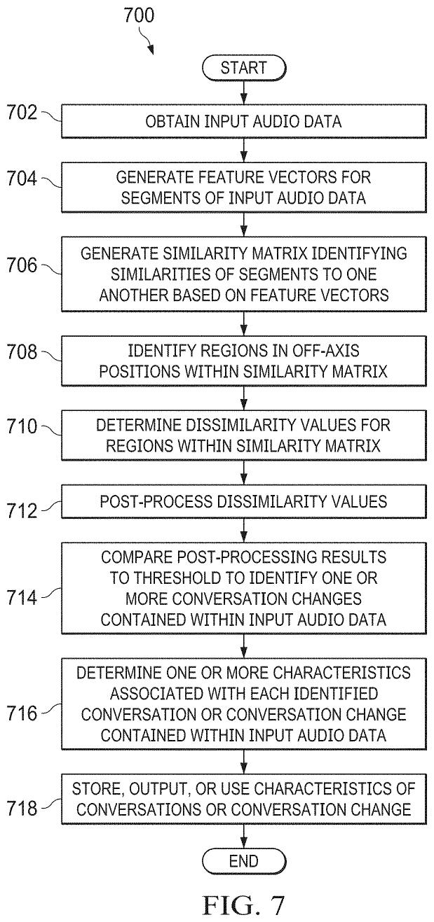

FIG. 7 illustrates an example method 700 for conversation diarization based on aggregate dissimilarity according to this disclosure. For ease of explanation, the method 700 of FIG. 7 is described as being performed using the application server 106 in the system 100 of FIG. 1, where the application server 106 is implemented using one or more instances of the device 200 of FIG. 2. However, the method 700 may be performed using any other suitable device(s) and in any other suitable system(s).

As shown in FIG. 7, input audio data is obtained at step 702. This may include, for example, the processing device 202 of the application server 106 obtaining input audio data 302 from a database 110, user device 102a-102d, or other suitable source(s). Feature vectors for segments of the input audio data are generated at step 704. This may include, for example, the processing device 202 of the application server 106 performing the feature extraction function 304 in order to extract audio features from segments of the audio data 302 having one-second, two-second, or other lengths and generate feature vectors.

A similarity matrix identifying similarities of the segments of audio data to one another is generated at step 706. This may include, for example, the processing device 202 of the application server 106 performing the similarity analysis function 306 in order to analyze the feature vectors and generate a similarity matrix 308 based on the analysis. Regions in off-axis positions within the similarity matrix are identified at step 708, and dissimilarity values are determined for the identified regions within the similarity matrix at step 710. This may include, for example, the processing device 202 of the application server 106 performing the dissimilarity identification function 310 in order to identify regions 312 within the similarity matrix 308. This may also include the processing device 202 of the application server 106 performing the dissimilarity identification function 310 in order to calculate a normalized sum or perform another calculation of a dissimilarity value for each region 312 based on the values within that region 312 of the similarity matrix 308.

Post-processing of the dissimilarity values occurs at step 712, and the results of the post-processing are compared to a threshold in order to identify one or more conversation changes within the input audio data at step 714. This may include, for example, the processing device 202 of the application server 106 performing the post-processing function 314 in order to smooth the dissimilarity values and identify peaks within the smoothed dissimilarity values. This may also include the processing device 202 of the application server 106 performing the post-processing function 314 in order to compare the smoothed dissimilarity values (such as the peaks of the smoothed dissimilarity values) to the threshold. One or more instances where the threshold is exceeded can be used to identify one or more conversation changes (and therefore two or more conversations) within the input audio data 302.

One or more characteristics may be determined for each identified conversation or conversation change within the input audio data at step 716. This may include, for example, the processing device 202 of the application server 106 performing the post-processing function 314 to identify a breakpoint between consecutive conversations within the input audio data 302. One or more breakpoints may be used to identify the time of each conversation change and/or the start and stop times of each conversation within the input audio data 302. The one or more characteristics may be stored, output, or used in some manner at step 718. This may include, for example, the processing device 202 of the application server 106 segmenting the input audio data 302 into different portions associated with different conversations. This may also include the processing device 202 of the application server 106 analyzing the different portions of the input audio data 302 in different ways or routing the different portions of the input audio data 302 (or analysis results for those portions of the input audio data 302) to different destinations.

Note that, in the discussion above, it is assumed the input audio data 302 represents single-channel audio data. If multi-channel audio data is being analyzed, steps 704-714 may be performed for each channel of the audio data. This can occur sequentially, concurrently, or in any other suitable manner. The results that are generated in step 714 for each channel of audio data may then be averaged, fused, or otherwise combined in order to identify one or more breakpoints within the multi-channel audio data.

Although FIG. 7 illustrates one example of a method 700 for conversation diarization based on aggregate dissimilarity, various changes may be made to FIG. 7. For example, while shown as a series of steps, various steps in FIG. 7 may overlap, occur in parallel, or occur any number of times.

The following describes example embodiments of this disclosure that implement or relate to conversation diarization based on aggregate dissimilarity. However, other embodiments may be used in accordance with the teachings of this disclosure.

In a first embodiment, a method includes obtaining input audio data that captures multiple conversations between speakers and extracting features of segments of the input audio data. The method also includes generating at least a portion of a similarity matrix based on the extracted features, where the similarity matrix identifies similarities of the segments of the input audio data to one another. The method further includes identifying dissimilarity values associated with different corresponding regions of the similarity matrix that are associated with different possible conversation changes. In addition, the method includes identifying one or more locations of conversation changes within the input audio data based on the dissimilarity values.

In a second embodiment, an apparatus includes at least one processing device configured to obtain input audio data that captures multiple conversations between speakers and extract features of segments of the input audio data. The at least one processing device is also configured to generate at least a portion of a similarity matrix based on the extracted features, where the similarity matrix identifies similarities of the segments of the input audio data to one another. The at least one processing device is further configured to identify dissimilarity values associated with different corresponding regions of the similarity matrix that are associated with different possible conversation changes and identify one or more locations of conversation changes within the input audio data based on the dissimilarity values.

In a third embodiment, a non-transitory computer readable medium contains instructions that when executed cause at least one processor to obtain input audio data that captures multiple conversations between speakers and extract features of segments of the input audio data. The medium also contains instructions that when executed cause the at least one processor to generate at least a portion of a similarity matrix based on the extracted features, where the similarity matrix identifies similarities of the segments of the input audio data to one another. The medium further contains instructions that when executed cause the at least one processor to identify dissimilarity values associated with different corresponding regions of the similarity matrix that are associated with different possible conversation changes and identify one or more locations of conversation changes within the input audio data based on the dissimilarity values.

Any single one or any suitable combination of the following features may be used with the first, second, or third embodiment. Each region of the similarity matrix may be located in an off-diagonal position within the similarity matrix. Each dissimilarity value may be determined based on values in the corresponding region of the similarity matrix. Each dissimilarity value may represent a measure of how dissimilar the segments of the input audio data associated with the values in the corresponding region of the similarity matrix are to one another. Each dissimilarity value may include a normalized sum of the values within the corresponding region of the similarity matrix. The one or more locations of the conversation changes within the input audio data may be identified by processing the dissimilarity values to produce processed dissimilarity values, comparing the processed dissimilarity values to a threshold, and identifying the one or more locations of the conversation changes within the input audio data based on one or more of the processed dissimilarity values exceeding the threshold. The dissimilarity values may be processed by smoothing the dissimilarity values and performing peak detection to identify peaks within the smoothed dissimilarity values. The input audio data may include multi-channel input audio data. The features may be extracted, the similarity matrix may be generated, and the dissimilarity values may be identified for each channel of the multi-channel input audio data. The one or more locations of the conversation changes within the input audio data may be identified based on the dissimilarity values for the multiple channels of the multi-channel input audio data. The input audio data may be segmented based on the one or more locations of the conversation changes. Different portions of the input audio data based on the one or more locations of the conversation changes may be routed to different destinations. Different portions of the input audio data based on the one or more locations of the conversation changes may be processed in different ways.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining input audio data that captures multiple conversations between speakers;
extracting features of segments of the input audio data;
generating at least a portion of a similarity matrix based on the extracted features, the similarity matrix identifying similarities of the segments of the input audio data to one another;
identifying dissimilarity values associated with different corresponding regions of the similarity matrix that are associated with different possible conversation changes; and
identifying one or more locations of conversation changes within the input audio data based on the dissimilarity values.

2. The method of claim 1, wherein:
each region of the similarity matrix is located in an off-diagonal position within the similarity matrix;
each dissimilarity value is determined based on values in the corresponding region of the similarity matrix; and
each dissimilarity value represents a measure of how dissimilar the segments of the input audio data associated with the values in the corresponding region of the similarity matrix are to one another.

3. The method of claim 2, wherein each dissimilarity value comprises a normalized sum of the values within the corresponding region of the similarity matrix.

4. The method of claim 1, wherein identifying the one or more locations of the conversation changes within the input audio data comprises:
processing the dissimilarity values to produce processed dissimilarity values;
comparing the processed dissimilarity values to a threshold; and
identifying the one or more locations of the conversation changes within the input audio data based on one or more of the processed dissimilarity values exceeding the threshold.

5. The method of claim 4, wherein processing the dissimilarity values comprises:
smoothing the dissimilarity values; and
performing peak detection to identify peaks within the smoothed dissimilarity values.

6. The method of claim 1, wherein:
the input audio data comprises multi-channel input audio data;
the features are extracted, the similarity matrix is generated, and the dissimilarity values are identified for each channel of the multi-channel input audio data; and
the one or more locations of the conversation changes within the input audio data are identified based on the dissimilarity values for the multiple channels of the multi-channel input audio data.

7. The method of claim 1, further comprising at least one of:
segmenting the input audio data based on the one or more locations of the conversation changes;
routing different portions of the input audio data based on the one or more locations of the conversation changes to different destinations; and
processing different portions of the input audio data based on the one or more locations of the conversation changes in different ways.

8. An apparatus comprising:
at least one processing device configured to:
obtain input audio data that captures multiple conversations between speakers;
extract features of segments of the input audio data;
generate at least a portion of a similarity matrix based on the extracted features, the similarity matrix identifying similarities of the segments of the input audio data to one another;
identify dissimilarity values associated with different corresponding regions of the similarity matrix that are associated with different possible conversation changes; and
identify one or more locations of conversation changes within the input audio data based on the dissimilarity values.

9. The apparatus of claim 8, wherein:
each region of the similarity matrix is located in an off-diagonal position within the similarity matrix;
the at least one processing device is configured to determine each dissimilarity value based on values in the corresponding region of the similarity matrix; and
each dissimilarity value represents a measure of how dissimilar the segments of the input audio data associated with the values in the corresponding region of the similarity matrix are to one another.

10. The apparatus of claim 9, wherein each dissimilarity value comprises a normalized sum of the values within the corresponding region of the similarity matrix.

11. The apparatus of claim 8, wherein, to identify the one or more locations of the conversation changes within the input audio data, the at least one processing device is configured to:
process the dissimilarity values to produce processed dissimilarity values;
compare the processed dissimilarity values to a threshold; and
identify the one or more locations of the conversation changes within the input audio data based on one or more of the processed dissimilarity values exceeding the threshold.

12. The apparatus of claim 11, wherein, to process the dissimilarity values, the at least one processing device is configured to:
smooth the dissimilarity values; and
perform peak detection to identify peaks within the smoothed dissimilarity values.

13. The apparatus of claim 8, wherein:
the input audio data comprises multi-channel input audio data;
the at least one processing device is configured to extract the features, generate the similarity matrix, and identify the dissimilarity values for each channel of the multi-channel input audio data; and
the at least one processing device is configured to identify the one or more locations of the conversation changes within the input audio data based on the dissimilarity values for each channel of the multi-channel input audio data.

14. The apparatus of claim 8, wherein the at least one processing device is further configured to at least one of:
segment the input audio data based on the one or more locations of the conversation changes;
route different portions of the input audio data based on the one or more locations of the conversation changes to different destinations; and
process different portions of the input audio data based on the one or more locations of the conversation changes in different ways.

15. A non-transitory computer readable medium containing instructions that when executed cause at least one processor to:
obtain input audio data that captures multiple conversations between speakers;
extract features of segments of the input audio data;
generate at least a portion of a similarity matrix based on the extracted features, the similarity matrix identifying similarities of the segments of the input audio data to one another;
identify dissimilarity values associated with different corresponding regions of the similarity matrix that are associated with different possible conversation changes; and
identify one or more locations of conversation changes within the input audio data based on the dissimilarity values.

16. The non-transitory computer readable medium of claim 15, wherein:
each region of the similarity matrix is located in an off-diagonal position within the similarity matrix;
the instructions when executed cause the at least one processor to determine each dissimilarity value based on values in the corresponding region of the similarity matrix; and
each dissimilarity value represents a measure of how dissimilar the segments of the input audio data associated with the values in the corresponding region of the similarity matrix are to one another.

17. The non-transitory computer readable medium of claim 15, wherein the instructions that when executed cause the at least one processor to identify the one or more locations of the conversation changes within the input audio data comprise:
instructions that when executed cause the at least one processor to:
process the dissimilarity values to produce processed dissimilarity values;
compare the processed dissimilarity values to a threshold; and
identify the one or more locations of the conversation changes within the input audio data based on one or more of the processed dissimilarity values exceeding the threshold.

18. The non-transitory computer readable medium of claim 17, wherein the instructions that when executed cause the at least one processor to process the dissimilarity values comprise:
instructions that when executed cause the at least one processor to:
smooth the dissimilarity values; and
perform peak detection to identify peaks within the smoothed dissimilarity values.

19. The non-transitory computer readable medium of claim 15, wherein:
the input audio data comprises multi-channel input audio data;
the instructions when executed cause the at least one processor to extract the features, generate the similarity matrix, and identify the dissimilarity values for each channel of the multi-channel input audio data; and
the instructions when executed cause the at least one processor to identify the one or more locations of the conversation changes within the input audio data based on the dissimilarity values for each channel of the multi-channel input audio data.

20. The non-transitory computer readable medium of claim 15, further containing the instructions that when executed cause the at least one processor to at least one of:
segment the input audio data based on the one or more locations of the conversation changes;
route different portions of the input audio data based on the one or more locations of the conversation changes to different destinations; and
process different portions of the input audio data based on the one or more locations of the conversation changes in different ways.
